(19) United States
(12) Patent Application Publication
(10) Pub. No.: US 2025/0181201 A1
(43) Pub. Date: Jun. 5, 2025

(54) TOUCH PANEL AND TOUCH APPARATUS

(71) Applicants: Hefei Visionox Technology Co., Ltd., Hefei (CN); KunShan Go-Visionox Opto-Electronics Co., Ltd., Kunshan (CN)

(72) Inventors: Lei ZHANG, Hefei (CN); Tongmin LIU, Hefei (CN); Qi WANG, Hefei (CN); Dong YAN, Hefei (CN); Xiujian ZHU, Hefei (CN)

(73) Assignees: Hefei Visionox Technology Co., Ltd., Hefei (CN); KunShan Go-Visionox Opto-Electronics Co., Ltd., Kunshan (CN)

(21) Appl. No.: 19/053,403

(22) Filed: Feb. 13, 2025

Related U.S. Application Data
(63) Continuation of application No. PCT/CN2023/074024, filed on Jan. 31, 2023.

(30) Foreign Application Priority Data
Sep. 7, 2022 (CN) 202211090708.1

(51) Int. Cl. G06F 3/044; G06F 3/041

(52) U.S. Cl. CPC G06F 3/0446; G06F 3/0418; G06F 3/0443; G06F 2203/04111; G06F 2203/04112

(57) ABSTRACT

A touch panel includes a touch function area and an electrode layer located in the touch function area. The electrode layer includes of first electrodes arranged in parallel and second electrodes arranged in parallel. The second electrodes are arranged to be spaced apart from the first electrodes and intersect with the first electrodes to form touch units at intersections. In at least one touch unit, a first electrode includes at least one first main electrode and at least one first sub-electrode connected to a first main electrode in the at least one first main electrode, and an extension direction of the first sub-electrode is disposed to be parallel with an extension direction of a touch channel determined by at least one of the first electrode and the second electrode.

### CROSS-REFERENCE TO RELATED APPLICATIONS

The present application is a continuation of International Application No. PCT/CN2023/074024 filed on Jan. 31, 2023, which claims priority to Chinese Patent Application No. 202211090708.1 filed on Sep. 7, 2022. All of the aforementioned patent applications are hereby incorporated by reference in their entireties.

### FIELD

The present disclosure relates to the field of touch control technologies, and in particular, to a touch panel and a touch apparatus.

### BACKGROUND

The application of electronic products having a touch function is increasingly popular in the market. However, touch electrodes used for realizing the touch function in current electronic products are limited to designs of pattern shapes. In a case that a touch operation is deflected at an angle, a touch precision and sensitivity may be reduced, and even a poor tough is caused, which is difficult to meet requirements of users.

### SUMMARY

In view of this, the present disclosure provides a touch panel and a touch apparatus, and a direction of an electric field distribution of a touch unit tends to be parallel to an extension direction of a touch channel by designing an electrode shape of a touch electrode, to alleviate problem of degradation of touch precision and sensitivity under a condition of deflection of a touch angle.

A first aspect of the present disclosure provides a touch panel, the touch panel includes a touch function area and an electrode layer located in the touch function area, and the electrode layer includes first electrodes arranged in parallel and second electrodes arranged in parallel. The second electrodes are arranged to be spaced apart from the first electrodes and intersect with the first electrodes to form units at intersections. In at least one touch unit of the touch units, a first electrode of the first electrodes includes at least one first main electrode and at least one first sub-electrode connected to a first main electrode in the at least one first main electrode, and an extension direction of the at least one first sub-electrode is disposed to be parallel to an extension direction of a touch channel determined by at least one of the first electrode and a second electrode in the second electrodes.

In above solution, the extension direction of the first sub-electrode is designed according to the extension direction of the touch channel determined by the first electrode or the second electrode, and when a touch detection is performed, an electric field formed in the touch unit may also tend to be distributed along the extension direction of the touch channel determined by the first electrode or the second electrode under a guidance of the first sub-electrode. A distribution of the electric field in this case may avoid excessive changes in touch precision and sensitivity in a case that a touch angle is deflected, to alleviate a problem of degradation of touch precision and sensitivity.

In above solution, the first sub-electrode may be provided with a greater design length in a single direction, to further divide an area of the distribution of the electric field, and make a direction of the distribution of the electric field tend to a single direction as a whole, to reduce a proportion of the electric field distributed in an inclined manner (intersecting but not perpendicular to the extension direction of the touch channel determined by the first electrode and the second electrode), and further alleviating the problem of degradation of touch precision and sensitivity.

In above solution, when a planar design area of the touch unit is limited, the first sub-electrode may be allowed to have a greater extension length, and the first sub-electrode has an additional bending part (for example, a junction of first extension parts with different extension directions) for aggregating charges, to regulate and control the distribution of the electric field in the touch unit, and make the distribution of the electric field in an entire touch unit relatively uniform. In addition, under a design of the above solution, it may still be ensured that the electric field tends to be distributed along the extension direction of the touch channel determined by the first electrode or the second electrode under the guidance of the first sub-electrode, to ensure that the problem of degradation of touch precision and sensitivity may be alleviated.

In a specific embodiment of the first aspect of the present disclosure, in each of the touch units, ends, facing away from the first main electrode, of all first sub-electrodes are arranged in rows, or columns, or rows and columns, directions of the rows are same as an extension direction of a touch channel determined by the second electrode, and directions of the columns are same as an extension direction of a touch channel determined by the first electrode.

Charges have a phenomenon of tip aggregation, in above solution, by designing an arrangement of the ends of the first sub-electrodes, all charge aggregation positions (equivalent to areas where the electric field is mainly distributed) formed by a guidance of the ends of the first sub-electrodes may also be distributed along an extension direction of a touch channel determined by the first electrode or the second electrode, to ensure that the problem of degradation of touch precision and sensitivity may be alleviated.

In a specific embodiment of the first aspect of the present disclosure, in each of the touch units, an edge, facing the at least one first sub-electrode, of the second electrode is conformal with an edge, facing the second electrode, of the at least one first sub-electrode.

In another specific embodiment of the first aspect of the present disclosure, in each of the touch units, each of second electrodes comprises at least one second main electrode and at least one second sub-electrode connected to a second main electrode of the at least one second main electrode, and the first main electrode intersects with the second main electrode.

In above solution, a design of the second sub-electrode facilitates the electric field to be relatively uniformly distributed in an area where the touch unit is located, to improve the touch sensitivity and precision of the touch unit.

In a specific embodiment of the first aspect of the present disclosure, in each of the touch units, ends, facing away from the second main electrode, of all the second sub-electrodes are arranged in rows, or columns, or rows and columns, directions of the rows are same as an extension direction of a touch channel determined by the second electrode, and directions of the columns are same as an extension direction of a touch channel determined by the first electrode.

In above solution, by designing an arrangement of the ends of the second sub-electrodes, all charge aggregation positions (equivalent to areas where the electric field is mainly distributed) formed by a guidance of the ends of the second sub-electrodes may also be distributed along an extension direction of a touch channel determined by the first electrode or the second electrode. In one embodiment, on a basis that the extension direction of the first sub-electrode is same as the extension direction of the touch channel determined by the first electrode and/or the second electrode, an electric field generated between the end of the second sub-electrode and the first sub-electrode still needs to be distributed follow the extension direction of the first sub-electrode, that is, the electric field may also be distributed along the extension direction of the touch channel determined by the first electrode or the second electrode, to ensure that the problem of degradation of touch precision and sensitivity may be alleviated.

In a specific embodiment of the first aspect of the present disclosure, an extension direction of a second sub-electrode of the at least one second sub-electrode is same as an extension direction of a touch channel determined by the first electrode and/or the second electrode.

In above solution, the extension direction of the second sub-electrode is designed according to the extension direction of the touch channel determined by the first electrode or the second electrode, and when a touch detection is performed, the electric field formed in the touch unit also tends to be distributed along the extension direction of the touch channel determined by the first electrode or the second electrode under a guidance of the second sub-electrode. A distribution of the electric field in this case may avoid excessive changes in touch precision and sensitivity in a case that a touch angle is deflected, to alleviate a problem of degradation of touch precision and sensitivity.

In a specific embodiment of the first aspect of the present disclosure, when the extension direction of the second sub-electrode is same as the extension direction of the touch channel determined by the first electrode and/or the second electrode, extension directions of second sub-electrodes are same as the extension direction of the touch channel determined by the first electrode, or extension directions of second sub-electrodes are same as the extension direction of the touch channel determined by the second sub-electrode.

In above solution, the second sub-electrode may be provided with a greater design length in a single direction, to further divide an area of the distribution of the electric field, and make a direction of the distribution of the electric field tends to a single direction as a whole, reducing reduce a proportion of the electric field distributed in an inclined manner (intersecting but not perpendicular to the extension direction of the touch channel determined by the first electrode and the second electrode), and further alleviating the problem of degradation of touch precision and sensitivity.

In another specific embodiment of the first aspect of the present disclosure, when the extension direction of the second sub-electrode is same as the extension direction of the touch channel determined by the first electrode and/or the second electrode, the second sub-electrode includes at least two second extension parts spliced together, an extension direction of a part of the at least two second extension parts is same as the extension direction of the touch channel determined by the first electrode, and an extension direction of another part of the at least two second extension parts is same as the extension direction of the touch channel determined by the second electrode.

In above solution, when a planar design area of the touch unit is limited, the first sub-electrode may be allowed to have a greater extension length, and the second sub-electrode has an additional bending part (for example, a junction of first extension parts with different extension directions) for aggregating charges, to regulate and control the distribution of the electric field in the touch unit, and make the distribution of the electric field in an entire touch unit relatively uniform. In addition, under a design of the above solution, it may still be ensured that the electric field tends to be distributed along the extension direction of the touch channel determined by the first electrode or the second electrode under the guidance of the second sub-electrode, to ensure that the problem of degradation of touch precision and sensitivity may be alleviated.

In a specific embodiment of the first aspect of the present disclosure, when the extension direction of the second sub-electrode is same as the extension direction of the touch channel determined by the first electrode and/or the second electrode, opposite edges of a first sub-electrode of the at least one first sub-electrode and the second sub-electrode adjacent to each other are parallel to each other, and an extension direction of a gap between the first sub-electrode and the second sub-electrode adjacent to each other is same as the extension direction of the touch channel determined by at least one of the first electrode and the second electrode. For example, further, the first sub-electrode and the second sub-electrode adjacent to each other are arranged in a staggered manner.

In above solution, not only a distribution of an electric field generated between the end of the second sub-electrode and the first sub-electrode (or another part of the first electrode) is same as the extension direction of the touch channel determined by the first electrode and/or the second electrode, but also the gap between the first sub-electrode and the second sub-electrode for generating an electric field extends along the extension direction of the touch channel determined by the first electrode and/or the second electrode, to further alleviate the problem of degradation of touch precision and sensitivity.

In a specific embodiment of the first aspect of the present disclosure, the first electrode and the second electrode are mesh electrodes.

In above solution, a capacitance of a touch capacitor formed by an entire touch unit may be reduced, and a magnitude of a parasitic capacitance generated between the first electrode and the second electrode and other conductive structures (for example, a shielding electrode layer, a cathode layer, or the like) may be reduced, to improve sensitivity of a touch detection. In addition, this design may improve a light transmittance of the touch panel, to further allow materials of the first electrode and the second electrode to be selected from materials (such as a metal or the like) with a high conductivity but poor light transmittance, to reduce a voltage drop of the touch channel and reduce an operating power consumption of the touch panel.

In a specific embodiment of the first aspect of the present disclosure, the touch panel further includes a display substrate, the display substrate is configured to carry the electrode layer and includes a display area, at least a part of the display area is located in the touch function area, and an orthographic projection, on the display substrate, of a mesh line of the mesh electrodes is located between sub-pixels.

In above solution, a blocking degree of the mesh electrodes on light emitted from the display substrate is small, and an entire touch panel (a touch display panel in this case) may have a higher display brightness without increasing a driving power consumption.

In a specific embodiment of the first aspect of the present disclosure, mesh openings of the mesh electrodes are in one-to-one correspondence with sub-pixels, and each of the sub-pixels is located within an orthographic projection, on a plane where the display substrate is located, of a mesh opening corresponding to the sub-pixel.

In above solution, the mesh electrodes do not block light emitted from the sub-pixels of the display substrate, to avoid a distortion of a display image of the touch panel (the touch display panel in this case).

A second aspect of the present disclosure provides a touch apparatus, and the touch apparatus includes the touch panel according to the first aspect.

### BRIEF DESCRIPTION OF THE DRAWINGS

FIG. 1 is a schematic diagram of a planar structure of a touch unit.

FIG. 2 is a schematic diagram of a planar structure of another touch unit.

FIG. 3 is a schematic diagram of touch offset errors in different electric field distribution patterns.

FIG. 4 is a schematic diagram of a planar structure of a touch panel according to an embodiment of the present disclosure.

FIG. 5 is an enlarged structural diagram of an electrode layer in an area S1 of the touch panel shown in FIG. 4.

FIG. 6 is a schematic diagram of a planar structure of a first electrode in the electrode layer shown in FIG. 5.

FIG. 7 is a schematic diagram of a planar structure of a second electrode in the electrode layer shown in FIG. 5.

FIG. 8 is a schematic diagram of a planar structure of a touch unit formed by the electrode layer shown in FIG. 5.

FIG. 9 is a schematic diagram of a planar structure of a first electrode in the electrode layer shown in FIG. 8.

FIG. 10 is a schematic diagram of a planar structure of a second electrode in the electrode layer shown in FIG. 8.

FIG. 11 is a cross-sectional view of the touch unit shown in FIG. 8 along the line M1-N1.

FIG. 12 is a cross-sectional view of the touch unit shown in FIG. 8 along the line M2-N2.

FIG. 13 is a cross-sectional view of another touch unit shown in FIG. 8 along the line M1-N1.

FIG. 14 is a cross-sectional view of another touch unit shown in FIG. 8 along the line M2-N2.

FIG. 15 is a schematic diagram of a planar structure of a touch unit in another touch panel according to an embodiment of the present disclosure.

FIG. 16A is a schematic diagram of a planar structure of a touch unit in another touch panel according to an embodiment of the present disclosure.

FIG. 16B is a cross-sectional view of the touch unit shown in FIG. 16A along the line M3-N3.

FIG. 16C is a cross-sectional view of the touch unit shown in FIG. 16A along the line M4-N4.

FIG. 17A is a schematic diagram of a planar structure of a touch unit in another touch panel according to an embodiment of the present disclosure.

FIG. 17B is a schematic diagram of a planar structure of a first electrode in the touch unit shown in FIG. 17A.

FIG. 17C is a schematic diagram of a planar structure of a second electrode in the touch unit shown in FIG. 17A.

FIG. 18 is a schematic diagram of a planar structure of a touch unit in another touch panel according to an embodiment of the present disclosure.

FIG. 19A is a schematic diagram of a planar structure of a touch unit in another touch panel according to an embodiment of the present disclosure.

FIG. 19B is a schematic diagram of a planar structure of a first electrode in the touch unit shown in FIG. 19A.

FIG. 19C is a schematic diagram of a planar structure of a second electrode in the touch unit shown in FIG. 19A.

FIG. 20A is a schematic diagram of a planar structure of a touch unit in another touch panel according to an embodiment of the present disclosure.

FIG. 20B is a schematic diagram of a planar structure of a first electrode in the touch unit shown in FIG. 20A.

FIG. 20C is a schematic diagram of a planar structure of a second electrode in the touch unit shown in FIG. 20A.

FIG. 21A is a schematic diagram of a planar structure of a touch unit in another touch panel according to an embodiment of the present disclosure.

FIG. 21B is a schematic diagram of a planar structure of a first electrode in the touch unit shown in FIG. 21A.

FIG. 21C is a schematic diagram of a planar structure of a second electrode in the touch unit shown in FIG. 21A.

FIG. 22 is an enlarged view of an area S2 of the touch unit shown in FIG. 8.

FIG. 23 is a cross-sectional view of the touch unit shown in FIG. 22 along the line M5-N5.

FIG. 24 is a schematic diagram of size parameters of the first electrode and the second electrode in the touch unit shown in FIG. 8.

### DETAILED DESCRIPTION OF THE EMBODIMENTS

Embodiments of the present disclosure are clearly and completely described below with reference to the accompanying drawings in the embodiments of the present disclosure. The described embodiments are only a part, but not all of the embodiments of the present disclosure.

A touch area of a touch panel is provided with a driving electrode and a sensing electrode, and the driving electrode and the sensing electrode intersect with each other and form a touch unit (equivalent to a capacitor structure) at an intersection. Each driving electrode and each sensing electrode determine a touch channel, respectively. For example, the driving electrode determines a scanning channel for applying a scanning signal, and the sensing electrode determines a sensing channel for sensing a capacitance change of the touch unit, to position a touch position.

In each touch unit, in order to increase a coverage area of the driving electrode and the sensing electrode, and form a relatively small gap between the driving electrode and the sensing electrode to form an electric field (an electric field of a capacitive structure during touch detection), the gap between the driving electrode and the sensing electrode may be set to intersect with but not perpendicular to extension directions of the driving electrode and the sensing electrode. For example, an extension direction of the driving electrode is perpendicular to an extension direction of the sensing electrode, an included angle between an extension direction of the gap and the extension direction of the driving electrode is substantially 45 degrees, and in that case, it may be considered that the gap is obliquely arranged.

However, in the case that the gap is an obliquely arranged, when a touch operation is performed by using a structure such as an active pen, poor touch may be often caused by small-angle deflection, such as interruption or uneven thickness of a drawn line. A main reason for this phenomenon is: a signal released by a sensor on the active pen can be directly applied to the driving electrode or the sensing electrode to affect the capacitance change or indirectly affect the capacitance change by affecting the electric field at the gap between the driving electrode and the sensing electrode, to ultimately position a touch position. A design of the gap described above makes a distribution of the electric field intersect with the touch channel, which makes positions where the signal may cause the capacitance change further dispersed, especially the electric field formed at the gap may be distributed in a divergent manner around a center, which makes main positions of the capacitance change caused by the signal relatively close. When the active pen deflects (an deflection angle is usually relatively small, for example, not more than twenty degrees), there is a large difference between an actual capacitance change and an expected capacitance change (expected value) under an undeflected state because of an offset of a position of the applied signal, which makes sensitivity of a touch detection unstable, and may even lead to determine that no touch (for example, an interruption occurs when drawing a line) occurs.

In the following, structures of some touch units with different structures are shown by means of several specific examples to illustrate a principle of insensitive touch detection caused by the obliquely arranged gap.

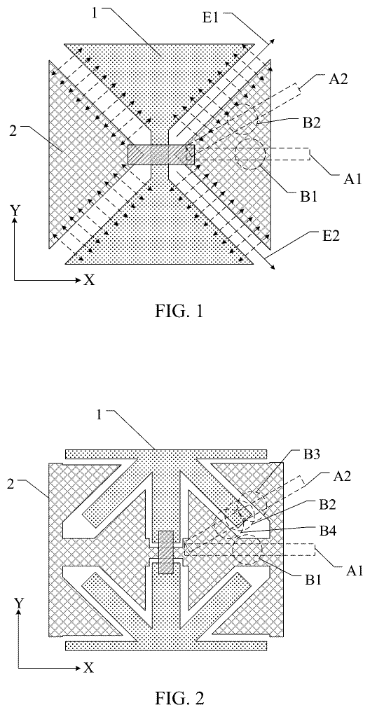

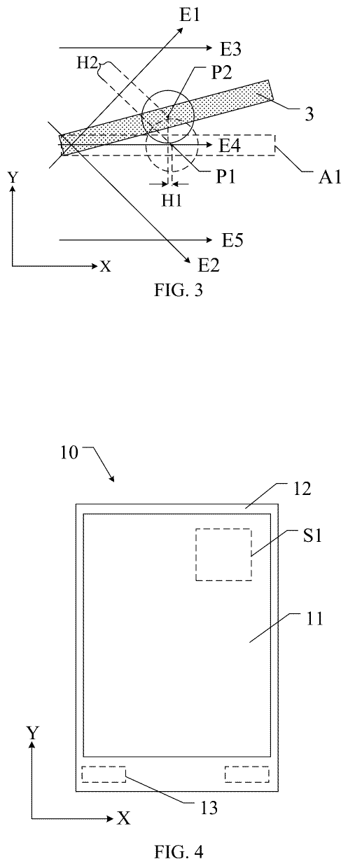

In an example, as shown in FIG. 1, a driving electrode 1 and a sensing electrode 2 include two approximately triangular electrode blocks in each touch unit, respectively, and an entire driving electrode 1 and an entire sensing electrode 2 are both formed by connecting rhombic electrodes. In this case, when a driving signal is applied to the driving electrode 1, an electric field is formed at a gap between the driving electrode 1 and the sensing electrode 2, and the electric field is distributed along extension directions E1 and E2 of the gap. During a touch operation, an active pen offsets from position A1 to position A2, and correspondingly, a sensor on the active pen offsets from position B1 to position B2. In one embodiment, the offset causes a signal applied by the sensor to be transferred from being applied mainly to the sensing electrode 2 to being mainly applied to the electric field formed at the gap, and an offset value of the offset is relatively large with respect to the extension direction E1 at the gap (see the relevant explanation in an example related to FIG. 3 below for details), and there is a large difference between the actual capacitance change and an expected value, which result in poor touch sensitivity.

In another example, as shown in FIG. 2, the driving electrode 1 and the sensing electrode 2 in each touch unit include extension parts presenting branches, respectively, extension directions of the extension parts intersect with extension directions of the driving electrode 1 and the sensing electrode 2, and ends of the extension parts are connected together to present a radial shape. In this way, an entire driving electrode 1 and an entire sensing electrode 2 are both formed by connecting radial electrodes, and a shape of a radial electrode is similar to three line segments intersecting at a point, that is, equivalent to the Chinese character “ [symbol] ” in shape. In this case, when the driving signal is applied to the driving electrode 1, an electric field is formed at the gap between the driving electrode 1 and the sensing electrode 2. During a touch operation, the active pen offsets from the position A1 to the position A2 to drive the sensor to offset from the position B1 to the position B2, and a signal applied by the sensor to be offset from being applied mainly to the sensing electrode 2 to being mainly applied to the electric field formed at the gap (positions B3 and B4). In view that the extension direction of the gap is obliquely arranged, an offset value of the offset is relatively large with respect to the extension direction at the gap, and for details, refer to the relevant explanation in the example related to FIG. 3 below, which may cause a problem of poor touch sensitivity mentioned above.

The principle that the obliquely arranged gap shown in FIGS. 1 and 2 described above results in a relatively large offset value of the offset with respect to the extension direction E1 at the gap may be seen in FIG. 3. In one embodiment, after an active pen 3 offsets from the position A1 to a current position, a center of a range of the signal applied by a sensor of the active pen 3 is offset from position P1 to position P2, and an offset value of the position P1 and the position P2 in the extension direction E1 is H2. In a case that the gap is obliquely arranged, the distribution of the electric field shows a radial shape as a whole, which makes charges tend to gather around, that is, a strength of the electric field tends to increase as the extension direction E1 (a direction of an arrow in FIG. 3) is further away from a radiation center. In this way, the position P1 is relatively far away from the extension direction E1 (actually the gap) and closer to the radiation center of the extension direction E1, and the position P2 is closer to the extension direction E1 (actually the gap) and farther away from the radiation center of the extension direction E1, and, a difference of capacitance change caused by the signal of the sensor at the position P1 and the position P2 is further increased because of a difference between a distance from the position P1 to the extension direction E1 and from the position P2 to the extension direction E1 and a difference between a distance from the position P1 to the radiation center and a distance from the position P2 to the radiation center.

In view of this, the present disclosure provides a touch panel and a touch apparatus to at least solve the above problem. The touch panel includes a touch function area and an electrode layer located in the touch function area, and the electrode layer includes first electrodes arranged in parallel and second electrodes arranged in parallel. The second electrodes are arranged to be spaced apart from the first electrodes and intersect with the first electrodes to form touch units at intersections. In at least one touch unit of the touch units, a first electrode of the first electrodes includes at least one first main electrode and at least one first sub-electrode connected to a first main electrode in the at least one first main electrode, and an extension direction of the at least one first sub-electrode is disposed to be parallel to an extension direction of a touch channel determined by at least one of the first electrode and a second electrode in the second electrodes. In the touch panel, an extension direction of the first sub-electrode is designed according to the extension direction of the touch channel determined by the first electrode or the second electrode, and when a touch detection is performed, an electric field formed in the touch unit may also tend to be distributed along the extension direction of the touch channel determined by the first electrode or the second electrode under a guidance of the first sub-electrode. A distribution of the electric field in this case may avoid excessive changes in touch precision and sensitivity in a case that a touch angle is deflected, to alleviate a problem of degradation of touch precision and sensitivity.

Exemplarily, it is assumed that directions of three first sub-electrodes of a touch unit are E3, E4 and E5 as shown in FIGS. 3, E3, E4 and E5 are parallel to each other and parallel to the extension direction of the touch channel determined by the first electrode or the second electrode. After an active pen 3 offsets from a position A1 to a current position, a center of a range of a signal applied by a sensor of the active pen 3 is offset from position P1 to position P2, and an offset value of the position P1 and the position P2 in an extension direction E4 is H1. It is assumed that an included angle of E1 and E4 is 45 degrees, H1 is less than H2 when a deflection angle of the active pen 3 is less than 22.5 degrees, and therefore, compared with a gap being obliquely arranged, the extension direction of the first sub-electrode is designed according to the extension direction of the touch channel, and there is a relatively smaller difference between an actual capacitance change after deflection and an expected value under an undeflected situation. It should be noted that a deflection of the active pen 3 is generally relatively small, because a presence of the deflection is required to be not easily perceived by a user's body or eyes, and thus the deflection angle is generally in a range from several degrees to more than ten degrees.

Structures of the touch panel and a touch apparatus in at least one embodiment of the present disclosure may be described below with reference to the accompanying drawings. It should be noted that, in the accompanying drawings, a space rectangular coordinate system is established based on a plane (or a touch surface) where the touch panel is located, to describe a position of each element in the touch panel. In the space rectangular coordinate system, the X-axis and the Y-axis are parallel to the plane where the touch panel is located, and the Z-axis is perpendicular to the plane where the touch panel is located. In a case that it is assumed that the first electrode is perpendicular to the second electrode in the accompanying drawings, the X-axis is set to be parallel to an extension direction of a touch channel determined by the first electrode, and the Y-axis is parallel to an extension direction of a touch channel determined by the second electrode.

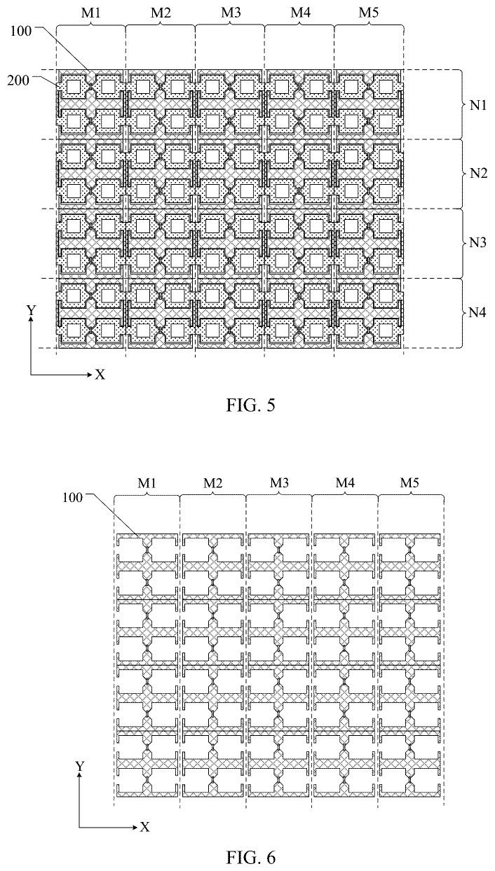

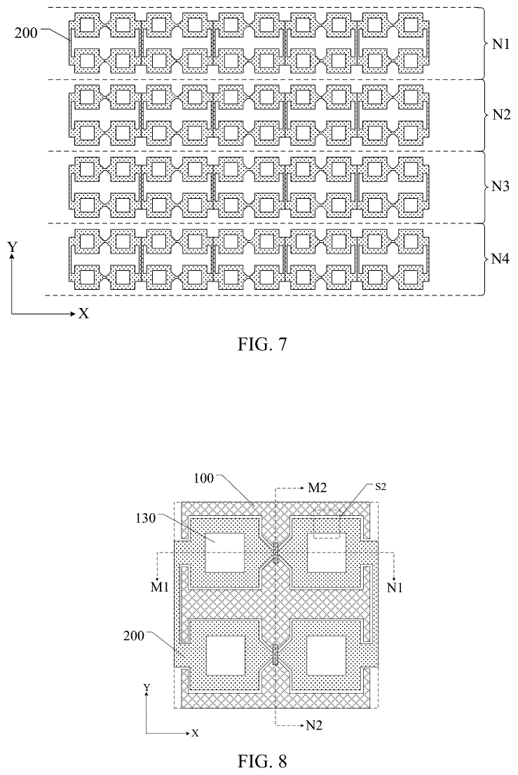

In at least one embodiment of the present disclosure, as shown in FIG. 4 to FIG. 12, a touch panel 10 includes a touch function area 11 and a line area 12 surrounding the touch function area 11. An electrode layer is disposed in the touch function area 11, and the electrode layer includes first electrodes 100 arranged in parallel and second electrodes 200 arranged in parallel. A first electrode 100 and a second electrode 200 are touch electrodes, and each touch electrode determines a channel. For example, longitudinal channels M1˜M5 determined by five first electrodes 100 and transverse channels N1˜N4 determined by four second electrodes 200 are shown in FIG. 5. For example, a lead wire area 13 is disposed in the line area 12, and signal lines connected to the touch electrodes are summarized in the lead wire area 13 to be transferred to other circuits (for example, finally transferred to a touch chip).

In the touch function area 11, the first electrode 100 and the second electrode 200 are spaced apart from each other and intersect with each other, and a touch unit is formed at each intersection of the first electrode 100 and the second electrode 200 as shown in FIG. 8, and an area where each touch unit is located is an overlapping area of a transverse channel and a longitudinal channel. In each touch unit, the first electrode 100 includes a first main electrode 110 and a first sub-electrode 120, and in a longitudinal channel where each first electrode 100 is located, the first main electrodes 110 in adjacent touch units are connected to each other. The first sub-electrode 120 is disposed on the first main electrode 110, and an extension direction of the first sub-electrode 120 is parallel to an extension direction of a touch channel determined by at least one of the first electrode 100 and the second electrode 200. During a touch detection, an electric field formed based on the first sub-electrode 120 may be distributed along an edge of the first sub-electrode 120. Since the first sub-electrode 120 is arranged to extend along an extension direction of the transverse channel and/or the longitudinal channel, the first sub-electrode 120 may make the electric field distribute along an extension direction of the transverse channel and/or the longitudinal channel, and a distribution of the electric field formed in the touch unit overall or locally presents rows (for example, E3, E4 and E5 parallel to each other) as shown in FIG. 3, to alleviate the problem of degradation of touch precision and sensitivity.

It should be noted that, in the embodiments of the present disclosure, extension directions of the first electrode and the second electrode may be understood as overall extension directions of the first electrodes and the second electrodes, and the touch channel is determined by the first electrode and the second electrode, and the extension direction of the first electrode may be equal to the extension direction of the touch channel determined by the first electrode, and the extension direction of the second electrode may be equivalent to the extension direction of the touch channel determined by the second electrode.

In an embodiment of the present disclosure, one of the first electrode and the second electrode is a driving electrode, and another one of the first electrode and the second electrode is a sensing electrode.

It should be noted that, in the embodiments of the present disclosure, when the extension direction of the first sub-electrode is determined based on the extension direction of the channel, a specific shape of the first sub-electrode may be regulated and controlled according to requirements of an actual process, which is not limited herein. In the following, several shapes of the first sub-electrode are exemplarily described.

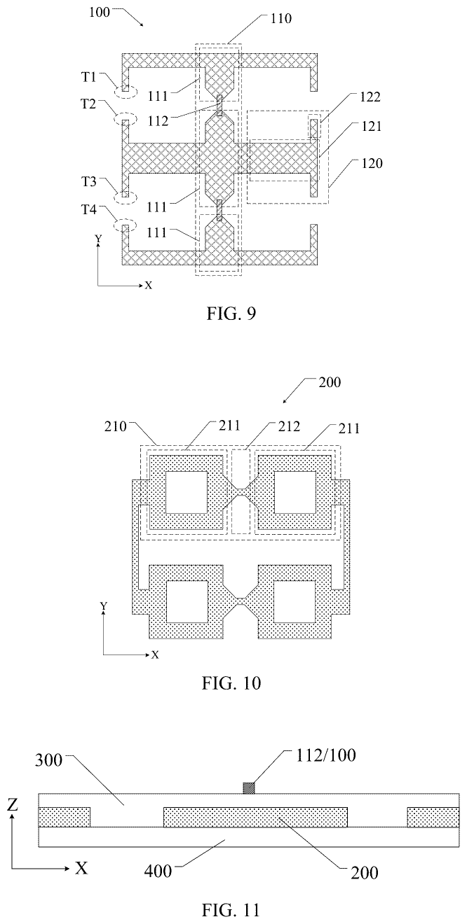

For example, in a touch panel according to some embodiments of the present disclosure, the first sub-electrode includes at least two first extension parts spliced together, an extension direction of a part of the at least two first extension parts is same as an extension direction of a touch channel determined by the first electrode, and an extension direction of another part of the at least two first extension parts is same as an extension direction of a touch channel determined by the second electrode. Exemplarily, as shown in FIG. 8 and FIG. 9, a first sub-electrode 120 includes a first extension part 121 and a first extension part 122 spliced together, the first extension part 121 is connected to the first main electrode 110, and the first extension part 122 is connected to the first main electrode 110 through the first extension part 121. An extension direction of the first extension part 121 is perpendicular to an extension direction (direction of the Y axis) of the first electrode 100, and an extension direction of the first extension part 122 is parallel to the extension direction of the first electrode 100. In this way, an edge, facing a second electrode 200, of the first extension part 121 may guide an electric field to be distributed along a direction of the X axis, and the electric field tends to be arranged in multiple rows. For example, in an electrode pattern shown in FIG. 9, six first extension parts 121 are approximately arranged in three rows and two columns, and edges, facing the second electrode 200, of the six first extension parts 121 are also arranged in four rows, to guide the electric field to tend to be arranged in four rows. It should be noted that, in view of a fact that a width of the first extension part 121 may be relatively small, and a distance between two rows in middle of the four rows is small, and electric fields of the two rows may also be treated in combination, and the six first extension parts 121 may be regarded as guiding the electric field to be arranged in three rows, specifically similar to E3, E4 and E5 shown in FIG. 3. The first extension parts 122 may guide the electric field to be distributed along the Y-axis, and the electric field tends to be arranged in columns, which is specifically similar to the deflection of the E3, E4 and E5 shown in FIG. 3 by 90 degrees. The first extension parts 122 guide the electric field in a manner similar to that of the first extension parts 121, and details are not described herein again. In above design, when a planar design area of the touch unit is limited, the first sub-electrode 120 may be allowed to have a larger extension length, and the first sub-electrode has an additional bending part (for example, a junction of the first extension part 121 and the first extension part 122) for aggregating charges, to regulate and control the distribution of the electric field in the touch unit, and make the distribution of the electric field in an entire touch unit relatively uniform. In addition, under the design, it may still be ensured that the electric field tends to be distributed along the extension direction of the first electrode 100 or the second electrode 120 under a guidance of the first sub-electrode 120, to ensure that the problem of degradation of touch precision and sensitivity may be alleviated.

It should be noted that, in a case that the first sub-electrode is composed of first extension parts spliced together, first extension parts of different first sub-electrodes may be spaced apart from each other as shown in FIG. 9, or may be connected to each other, and the two adjacent first sub-electrodes may cooperate with the first main electrode to form an annular electrode structure.

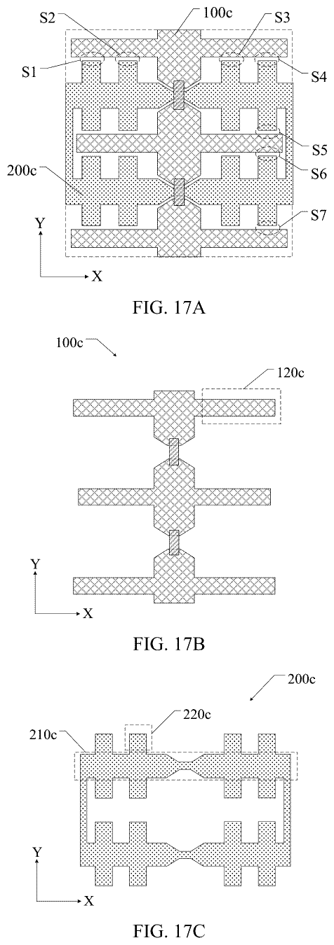

For example, in a touch panel according to some other embodiments of the present disclosure, extension directions of first sub-electrodes are same as an extension direction of a touch channel determined by the first electrode, or extension directions of the first sub-electrodes are same as an extension direction of a touch channel determined by the second electrode, that is, all the first sub-electrodes are arranged to extend in a specific direction. In this way, the first sub-electrodes may have a larger design length in a single direction, to further divide an electric field distribution area, and make a direction of the distribution of the electric field tends to a single direction as a whole, to reduce a proportion of the electric field distributed in an inclined manner (intersecting but not perpendicular to extension directions of the first electrode and the second electrode), and further alleviating the problem of degradation of touch precision and sensitivity. A shape of a first sub-electrode may be referred to the following related description based on the embodiments shown in FIG. 17A to FIG. 17C, and details are not described herein again.

Charges may present tip aggregation in an electrode structure, in this way, a relatively stronger electric field may be formed near an end of the first sub-electrode facing away from the first main electrode. If the ends of the first sub-electrodes are arranged and electric field accumulation areas with higher intensity are arranged in a form of rows (parallel to the extension direction of one channel) or columns (parallel to the extension direction of another channel), electric fields in a touch unit may also be arranged macroscopically in a form of substantially rows or columns.

For example, in each touch unit of the touch panel provided by at least one embodiment of the present disclosure, ends, facing away from the first main electrode, of all first sub-electrodes are arranged in rows, or columns, or rows and columns, directions of the rows are same as an extension direction of a touch channel determined by the second electrode, and directions of the columns are same as an extension direction of a touch channel determined by the first electrode. Exemplarily, as shown in FIG. 9, at one side of a first main electrode 110, ends of first sub-electrodes 120 are arranged in a column along an extension direction of a first electrode 100, and distribution areas T1-T4 of high-strength electric fields that may be formed at the ends are also arranged in a column, that is, electric fields formed at the ends of the first sub-electrodes 120 may be arranged in two columns on two sides of the first main electrode 110. In this way, by designing an arrangement of the ends of the first sub-electrodes 120, all charge aggregation positions (equivalent to the areas T1-T4 where the electric field is mainly distributed) formed by a guidance of the ends of the first sub-electrodes 120 may also be distributed along an extension direction of the first electrode 100 or a second electrode 200, to ensure that the problem of degradation of touch precision and sensitivity may be alleviated.

In the touch unit, although a formation of the electric field requires both the first electrode and the second electrode to participate, based on above design of the first electrode, the electric field has been guided to a distribution form in which rows, or columns, or rows and columns are macroscopically presented. On this basis, a specific shape of the second electrode is not limited, and the second electrode may be designed according to different requirements. In the following, several shapes of the second electrode are described through several specific embodiments.

For example, in some embodiments of the present disclosure, the second electrode may be provided with only a main electrode, that is, an entire second electrode serve as a current channel. Exemplarily, as shown in FIG. 8 to FIG. 10, a portion, located between first sub-electrodes 120 of a first electrode 100, of a second electrode 200 is provided to have an edge conformal with the first sub-electrode 120, and an extension direction of a gap between the first sub-electrode 120 and the second electrode 200 is substantially same as an extension direction of the first sub-electrode 120.

For example, in some other embodiments of the present disclosure, in each touch unit, each second electrode includes at least one second main electrode and at least one second sub-electrode connected to a second main electrode of the at least one second main electrode, and the first main electrode intersects with the second main electrode. Exemplarily, as shown in FIG. 17A to FIG. 17C, a second electrode 200c includes a second main electrode 210c and a second sub-electrode 220c, in a transverse channel where each second electrode 200c is located, the second main electrodes 210c in adjacent touch units are connected to each other, and the second sub-electrode 220c is disposed on the second main electrode 210c. An arrangement of the second sub-electrode 220c helps an electric field to be relatively uniformly distributed in an area where the touch unit is located, to improve touch sensitivity and precision of the touch unit.

As the related description of the first sub-electrode described above, charges may present tip aggregation in the electrode structure, and when the second electrode includes the second sub-electrode, ends, facing away from the second main electrode, of the second sub-electrodes may be arranged, and electric field accumulation areas with higher intensity formed at the ends of the second sub-electrodes are arranged in a form of rows (parallel to an extension direction of one channel) or columns (parallel to an extension direction of another channel). Thus, the second sub-electrodes cooperate with the first sub-electrodes to make electric fields in a touch unit be further arranged macroscopically in a form of substantially rows or columns.

For example, in each touch unit, ends, facing away from the second main electrode, of all second sub-electrodes are arranged in rows, or columns, or rows and columns, directions of the rows are same as the extension direction of the touch channel determined by the second electrode, and directions of the columns are same as the extension direction of the touch channel determined by the first electrode. Exemplarily, as shown in FIG. 17A to FIG. 17C, an extension direction of a first sub-electrode 120c of a first electrode 100c is same as the extension direction of a second electrode 200c. Ends of the second sub-electrodes 220c are arranged in rows and columns, and correspondingly, distribution areas (for example, areas S1-S7, and the like) of high-strength electric fields that may be formed at the ends of the second sub-electrodes 220c are also arranged in rows and columns. For example, the areas S1 to S4 in FIG. 17A are arranged in a row, and the areas S4 to S7 are arranged in a column. In this way, by designing an arrangement of the ends of the second sub-electrodes 220c, all charge aggregation positions (equivalent to areas where the electric field is mainly distributed) formed by a guidance of the ends of the second sub-electrodes 220c may also be distributed along the extension direction of the first electrode or the second electrode. On a basis that the extension direction of the first sub-electrode 120c is same as the extension direction of the first electrode 100c and/or the second electrode 200c, electric fields generated between ends of the second sub-electrodes 220c and the first sub-electrodes 100c still needs to follow the extension direction of the first sub-electrode to be distributed, that is, the electric fields may also be distributed along the extension direction of the first electrode 100c and/or the second electrode 200c, to ensure that the problem of degradation of touch precision and sensitivity may be alleviated.

In the embodiments of the present disclosure, an extension direction of a second sub-electrode may be designed according to different requirements. For example, the second sub-electrode may be designed with reference to a design concept of a first sub-electrode, and a direction of a distribution of an electric field in a touch unit is same as an extension direction of a touch channel determined by the first electrode and/or the second electrode to a greater extent through the second sub-electrode. In one embodiment, only an arrangement of ends of the second sub-electrodes is adjusted, and an overall extension direction of the second sub-electrodes is not limited, and an arrangement direction of aggregation areas with stronger electric fields is same as the extension direction of the touch channel determined by the first electrode and/or the second electrode, to reduce a proportion of the electric field distributed in an inclined manner (intersecting but not perpendicular to the extension direction of the touch channel determined by the first electrode and the second electrode). In the following, several distribution manners of the second sub-electrodes are described through several specific embodiments.

For example, in some embodiments of the present disclosure, the extension direction of the second sub-electrode is same as the extension direction of the touch channel determined by the first electrode and/or the second electrode. For a concept of this design, reference may be made to the foregoing related description of an arrangement manner of the first sub-electrodes, it is mainly to further guide the distribution of the electric field in the touch unit by the second sub-electrode when a touch detection is performed, to make the electric field tend to be distributed along the extension direction of the touch channel determined by the first electrode or the second electrode. In this case, the distribution of the electric field guided by the second sub-electrode may overall or locally present to tend to be distributed in rows (for example, E3, E4 and E5 parallel to each other) as shown in FIG. 3, and therefore, the design may further avoid excessive changes in touch precision and sensitivity in a case that a touch angle is deflected, to further alleviate the problem of degradation of touch precision and sensitivity.

It should be noted that, in the embodiments of the present disclosure, similar to the foregoing design of the first sub-electrode, in a case that the extension direction of the second sub-electrode is determined based on the extension direction of the channel (the first electrode and/or the second electrode), the second sub-electrode may be arranged to extend in one direction or in directions, and a specific shape may be adjusted and controlled according to requirement of an actual process, which is not limited herein. In the following, several shapes of the second sub-electrode are exemplarily described.

For example, in the touch panel provided by some embodiments of the present disclosure, when an extension direction of a second sub-electrode is same as an extension direction of a touch channel determined by a first electrode and/or a second electrode, the extension directions of the second sub-electrodes are same as the extension direction of the touch channel determined by the first electrode, or the extension directions of the second sub-electrodes are same as the extension direction of the touch channel determined by the second electrode, that is, all the second sub-electrodes are arranged to extend in a specific direction. Exemplarily, as shown in FIG. 17A to FIG. 17C, an extension direction of each second sub-electrode 220c is same as an extension direction (a direction of the Y-axis) of the first electrode 100c, and an extension direction of the first sub-electrode 120c is same as an extension direction (a direction of the X-axis) of the second electrode 200c. In this way, the extension direction of the second sub-electrode 220c is designed according to the extension direction (the extension direction of the touch channel) of the first electrode 100c or the second electrode 200c, and the second sub-electrode 200c may be provided with a larger design length in a single direction, to further divide an area of a distribution of an electric field, and make a direction of the distribution of the electric field tend to a single direction as a whole, to reduce a proportion of the electric field distributed in an inclined manner (intersecting but not perpendicular to the extension direction of the touch channel determined by the first electrode 100c and the second electrode 200c), and further alleviating the problem of degradation of touch precision and sensitivity.

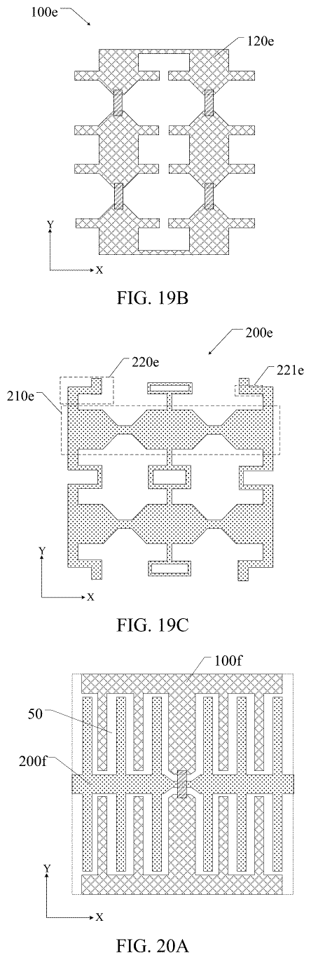

For example, in the touch panel provided by some embodiments of the present disclosure, when an extension direction of a second sub-electrode is same as an extension direction of a touch channel determined by a first electrode and/or a second electrode, the second sub-electrode includes at least two second extension parts spliced together, an extension direction of a part of the at least two second extension parts is same as the extension direction of the touch channel determined by the first electrode, and an extension direction of another part of the at least two second extension parts is same as the extension direction of the touch channel determined by the second electrode. Exemplarily, as shown in FIG. 19A to FIG. 19C, a second sub-electrode 220e is formed by sequentially connecting three second extension parts 221e, and one of the three second extension parts 221e connected together is connected to a second main electrode 210e. In the three second extension parts 221e connected together, an extension direction of one second extension part 221e is same as an extension direction of a second electrode 200e, and extension directions of another two second extension parts 221e are same as the extension direction of a first electrode 100e. For a principle of guiding a distribution of the electric field by the above design of the second extension parts 221e, reference may be made to related descriptions of the first extension parts in the foregoing embodiments, and details are not repeated herein again. In this way, when a planar design area of the touch unit is limited, the second sub-electrode 220e may be allowed to have a greater extension length, and the second sub-electrode 220e has an additional bending part (for example, a junction of the second extension parts with different extension directions) for aggregating charges, to regulate and control the distribution of the electric field in the touch unit, and make the distribution of the electric field in an entire touch unit relatively uniform. In addition, under a design of the above solution, it may still be ensured that the electric field tends to be distributed along the extension direction of the first electrode 100e or the second electrode 200e under a guidance of the second sub-electrode 220e, to ensure that the problem of degradation of touch precision and sensitivity may be alleviated. For a principle of guiding the distribution of the electric field by the above design of the second extension parts 221e, reference may be made to related descriptions of the first extension parts in the foregoing embodiments, and details are not repeated herein again.

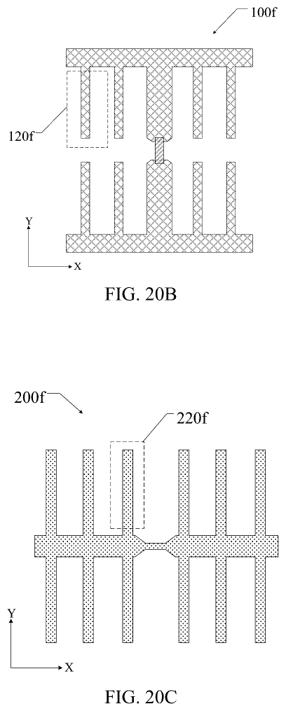

In an embodiment of the present disclosure, when an extension direction of a second sub-electrode is same as an extension direction of a touch channel determined by a first electrode and/or a second electrode, a shape of a second sub-electrode may be designed to match a shape of a first sub-electrode adjacent to the second sub-electrode, and an extension direction of a gap between the first sub-electrode and the second sub-electrode is same as a direction of a channel. For example, opposite edges of the first sub-electrode and the second sub-electrode adjacent to each other are parallel to each other, and an extension direction of a gap between the first sub-electrode and the second sub-electrode adjacent to each other is same as the extension direction of the touch channel determined by the first electrode and/or the second electrode. Exemplarily, as shown in FIG. 19A to FIG. 19C, the opposite edges of the first sub-electrode 120e and the second sub-electrode 220e are bent shapes, but the edges of the first sub-electrode 120e and the second sub-electrode 220e are conformal, and a width of a gap between the first sub-electrode 120e and the second sub-electrode 220e is same everywhere. In addition, Exemplarily, as shown in FIGS. 20A to 20C, opposite edges of a first sub-electrode 120f and a second sub-electrode 220f are straight lines parallel to each other, and the edges of the first sub-electrode 120f and the second sub-electrode 220f are also conformal, and a width of a gap 50 between the first sub-electrode 120f and the second sub-electrode 220f is same everywhere. In this way, not only a distribution of an electric field generated between the end of the second sub-electrode and the first sub-electrode (or another part of the first electrode) is same as the extension direction of the first electrode and/or the second electrode, but also the gap between the first sub-electrode and the second sub-electrode for generating the electric field extends along the extension direction of the first electrode and/or the second electrode, to further alleviate the problem of degradation of touch precision and sensitivity.

For example, in a case that opposite edges of the first sub-electrode and the second sub-electrode adjacent to each other are parallel to each other, the first sub-electrode and the second sub-electrode adjacent to each other may be arranged in a staggered manner. Exemplarily, as shown in FIGS. 20A to 20C, each first main electrode is provided with first sub-electrodes 120f, each second main electrode is provided with second sub-electrodes 220f, and in an area between the first main electrode and the second main electrode, the first sub-electrodes 120f and the second sub-electrodes 220f are arranged in a staggered manner. In this way, gaps between the first sub-electrodes 120f and the second sub-electrodes 220f may also be staggered, and the distribution of the electric field further presents rows or columns (columns presented as FIG. 20A), to further alleviate the problem of degradation of touch precision and sensitivity.

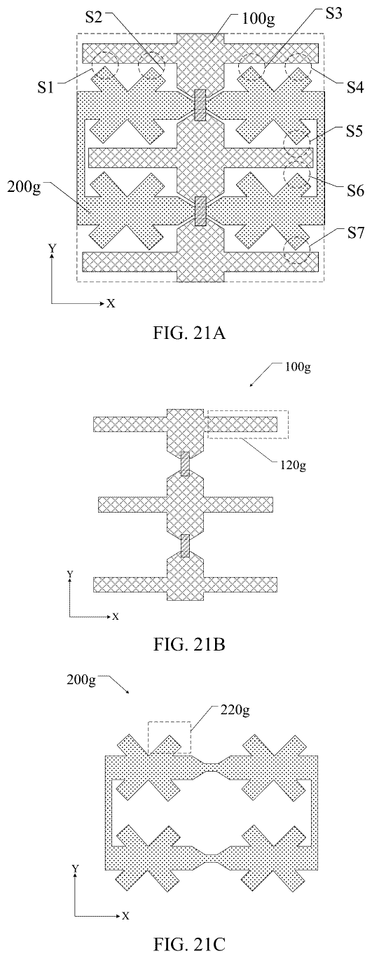

For example, in some other embodiments of the present disclosure, an extension direction of the second sub-electrode intersects with but is not perpendicular to extension directions of touch channels determined by the first electrode and the second electrode. Exemplarily, as shown in FIG. 21A to FIG. 21C, an extension direction of a second sub-electrode 220g intersects with and is not perpendicular to an extension direction of a first electrode 100g and an extension direction of a second electrode 200g. In this design, by a guidance of the second sub-electrodes 220g arranged radially, charges may be further concentrated in areas where the ends of the second sub-electrodes 220g are located, such as S1-S7, and a degree of charge aggregation of other areas (for example, areas near the second main electrode) is reduced. In this way, at the same time that a distribution of an electric field presents a plurality rows and columns, a distance between rows or columns (such as a distance between E3, E4 and E5 shown in FIG. 3) may be increased, to reduce a degree of an influence of a deflection of an active pen on an electric field intensity in adjacent rows or adjacent columns, or allow a larger offset value when using an active pen, to further alleviate the problem of degradation of touch precision and sensitivity.

It should be noted that, in a touch unit, the electric field may also be aggregated near an intersection of the first electrode and the second electrode, and an intersection of the first electrode and the second electrode are actually realized through the first main electrode and the second main electrode, that is, the number of the first main electrodes and the second main electrodes determines the number of intersections, and also affects the distribution of the electric field in an entire touch unit. It should be understood that, when the second electrode does not include the second sub-electrode, a part, located in the touch unit, of the second electrode is the second main electrode. In the following, structures of the touch unit in a case of including different numbers of first main electrodes and second main electrodes are described through several specific examples.

For example, in the first specific example of the present disclosure, there is only one first main electrode and one second main electrode in each of the touch units. In one embodiment, as shown in FIG. 20A to FIG. 20C, a first electrode 100f intersects with a second electrode 200f through one main electrode included in the first electrode 100f and one main electrode included in the second electrode 200f, to form an intersection in each of the touch units. A capacitor between the first electrode 100f and the second electrode 200f is constructed mainly through the first sub-electrode 120f of the first electrode 100f and the second sub-electrode 220f of the second electrode 200f, which are adjacent to each other.

For example, in the second specific example of the present disclosure, in each of the touch units, the number of the first main electrode is one and the number of the second main electrode is at least two. In one embodiment, referring to FIG. 8 to FIG. 10 again, the first electrode 100 includes a first main electrode 110, and the second electrode 200 includes two second main electrodes 210, and two intersections are formed in each of the touch units, and an arrangement direction of the two intersections is same as the extension direction of the first electrode 100, that is, the electric fields generated at the intersections may also be arranged along the extension direction of the first electrode 100.

For example, in the third specific example of the present disclosure, in each of the touch units, the number of one of the first main electrode and the second main electrode is at least two, and the number of another of the first main electrode and the second main electrode is one. In one embodiment, referring to FIG. 8 to FIG. 10 again, the first electrode 100 includes a first main electrode 110, and the second electrode 200 includes two second main electrodes 210 connected in parallel, and two intersections are formed in each of the touch units. An arrangement direction of the two intersections is same as the extension direction of the first electrode 100, that is, the electric fields generated at the intersections may also be arranged along the extension direction of the first electrode 100. In addition, the foregoing design may also refer to the touch unit shown in FIG. 17A to FIG. 17C and FIG. 21A to FIG. 21C.

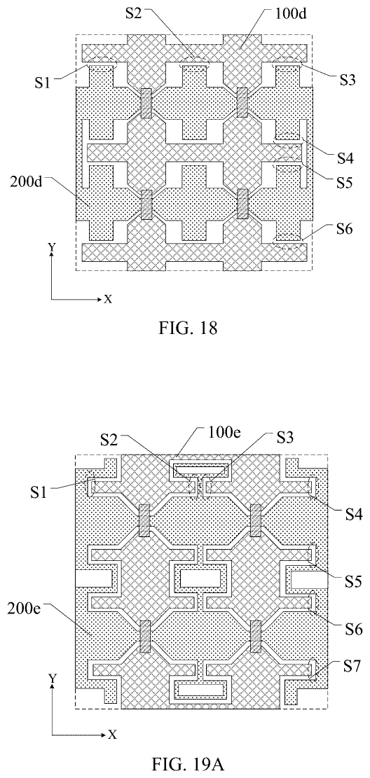

For example, in the fourth specific example of the present disclosure, in each of the touch units, both the number of the first main electrode and the number of the second main electrode are at least two. In one embodiment, referring to FIG. 19A to FIG. 19C again, the first electrode 100e includes two first main electrodes connected in parallel, and the second electrode 200e includes two second main electrodes connected in parallel, and four intersections are formed in each of the touch units, and the four intersections are arranged in two rows and two columns, that is, the electric fields generated at the intersections may also be arranged along the extension directions of the first electrode 100e and the second electrode 200e. In addition, the foregoing design may also refer to the touch unit shown in FIG. 18.

In the embodiments of the present disclosure, the “intersection” may be an area where the first main electrode and the second main electrode overlap. In one embodiment, as shown in FIG. 8 to FIG. 10, in each of the touch units, each first main electrode 110 includes at least one first connection part 112 and at least two first electrode blocks 111, and the first electrode blocks 111 are connected through the first connection part 112. Each second main electrode 210 includes at least one second connection part 212 and at least two second electrode blocks 211, the second electrode blocks 211 are connected through the second connection part 212, and the first connection part 112 and the second connection part 212 are located in different layers and intersect with each other. The first main electrode 110 intersects with the second main electrode 210 through the first connection part 112 and the second connection part 212, and the “intersection” is an area where the first connection part 112 and the second connection part 212 overlap.

An area of the area where the “intersection” is located is relatively small, and a distance between the first electrode and the second electrode is relatively close, and the electric field is accumulated, that is, an influence of shapes of adjacent edges of a first electrode block and a second electrode block at the “intersection” on the distribution of the electric field is relatively small. Therefore, the shapes of the adjacent edges of the first electrode block and the second electrode block at the “intersection” may be designed according to requirements of an actual process.

For example, in some embodiments of the present disclosure, as shown in FIG. 8 to FIG. 10, edges of the first electrode block 111 opposite to each other and edges of the second electrode block 211 opposite to each other are contracted towards the intersection, and an end, facing the intersection, of the first electrode block 111 and an end, facing the intersection, of the second electrode block 211 are presented with a triangular shape or a trapezoidal shape as shown in FIG. 9.

For example, in some other embodiments of the present disclosure, at an intersection, an extension direction of a gap between a first electrode and a second electrode is also arranged to be same as an extension direction of the touch channel determined by the first electrode and/or the second electrode. In one embodiment, as shown in FIG. 15, an extension direction of a gap between a second connection part of a second electrode 200a and a first main electrode of a first electrode 100a is same as an extension direction of the second electrode 200a.

As can be seen from the embodiments of the present disclosure as described above, an electrode pattern in the touch unit is affected by design elements such as a shape of the first extension part, a situation that the second extension part is provided or not provided, a shape of the second extension part, the number of the first main electrode and the second main electrode, and the shapes of the first electrode block and the second electrode block. In an actual process, the design elements like these may be selected according to requirements to obtain a corresponding electrode pattern, which is not limited herein. Several specific electrode patterns of the touch unit are described below through several specific examples.

For example, in a touch unit shown in FIG. 8 to FIG. 10, the first electrode 100 includes one first main electrode 110, and the second electrode 200 includes two second main electrodes 210. In this way, two intersections are formed, the first main electrode 110 includes three first electrode blocks 111 and two first connection parts 112 (conductive bridges as shown in the drawings), and each second main electrode 210 includes two second electrode blocks 211 and one second connection part 212. Two first sub-electrodes 120 are provided on both sides of each first electrode block 111, and a second sub-electrode is not provided on the second electrode block 211, that is, the second main electrode 210 includes only the second electrode blocks 211 and the second connection part 212. Each second electrode block 211 is sandwiched between two first sub-electrodes 120 on different first electrode blocks 111. Two first sub-electrodes 120 connected to a same first electrode block 111, two second electrode blocks 211 included in each second main electrode 210 are symmetrically arranged, a symmetry axis is a central axis of the first main electrode 110, and the central axis is parallel to an extension direction (a direction of the Y-axis) of the first electrode 100. The first sub-electrode 120 connected to the first electrode block 111 located in middle is composed of three first extension parts, one first extension part 121 extending in a same direction as an extension direction of the second electrode 200 is connected to the first electrode block 111, and another two first extension parts 122 extending in a same direction as an extension direction of the first electrode 100 are arranged on two sides of the first extension part 121, and the first sub-electrode 120 at this position is T-shaped. Each of the first sub-electrodes 120 connected to the first electrode blocks 111 located at two ends respectively includes two first extension parts, one first extension part 121 extending in a same direction as the extension direction of the second electrode 200 is connected to the first electrode block 111, and another first extension part 122 extending in a same direction as the extension direction of the first electrode 100 is disposed on a side, facing the second electrode 200, of the first extension part 121, and the first sub-electrode 120 at this position is L-shaped. A shape of the second electrode block 211 is substantially rectangular to match a shape (edges are conformal) of an adjacent first sub-electrode 120.

For example, in a touch unit shown in FIG. 17A to FIG. 17C, a first electrode 100c includes one first main electrode, and a second electrode 200c includes two second main electrodes. In this way, two intersections are formed, the first main electrode includes three first electrode blocks and two first connection parts (conductive bridges as shown in the drawings), and each second main electrode includes two second electrode blocks and one second connection part. Two first sub-electrodes are provided on both sides of each first electrode block, and a shape of the first sub-electrode is rectangular. A length direction of the rectangular is same as an extension direction of the second electrode 200c, and two ends of the two second main electrodes are respectively connected to each other. Four second sub-electrodes are arranged on each second electrode block, each second electrode block is provided with two second sub-electrodes on each side of the second electrode block, and the four second sub-electrodes are symmetrically arranged in pairs with the second electrode block as a symmetry axis. In this way, each second electrode block and the four second sub-electrodes disposed thereon are sandwiched between two first sub-electrodes connected to different first electrode blocks. Portions of the first electrode 100c and the second electrode 200c in each of the touch units are axisymmetric in a transverse direction (a direction of the X axis) and a longitudinal direction (a direction of the Y axis).

For example, in a touch unit shown in FIG. 18, a first electrode 100d includes two first main electrodes, and a second electrode 200d includes two second main electrodes. In this way, four intersections are formed, each first main electrode includes three first electrode blocks and two first connection parts (conductive bridges as shown in the drawings), and each second main electrode also includes three second electrode blocks and two second connection parts. Two first sub-electrodes are provided on two sides of each first electrode block, a first sub-electrode located between the two first main electrodes is shared by the two first main electrodes, a shape of the first sub-electrode is rectangular, and a length direction (an extension direction) of the rectangle is same as an extension direction of the second electrode 200d. Two second sub-electrodes are provided on two sides of each second electrode block, the two second sub-electrodes on each second electrode block are symmetrically arranged with the second electrode block as a symmetry axis, and two ends of the two second main electrodes are respectively connected to each other. In this way, each second electrode block and the two second sub-electrodes disposed thereon are sandwiched between two first sub-electrodes connected to different first electrode blocks. In the touch unit, portions of the first electrode 100d and the second electrode 200d in each of the touch units are axisymmetric in a transverse direction (a direction of the X axis) and a longitudinal direction (a direction of the Y axis).

For example, in a touch unit shown in FIG. 19A to FIG. 19C, the first electrode 100e includes two first main electrodes, and the second electrode 200e includes two second main electrodes. In this way, four intersections are formed, each first main electrode includes three first electrode blocks and two first connection parts (conductive bridges as shown in the drawings), and each second main electrode also includes three second electrode blocks and two second connection parts. Two sides of each of first electrode blocks located on two sides of each first main electrode are respectively provided with a first sub-electrode, and two sides of a first electrode block located in middle are respectively provided with two first sub-electrodes. A shape of the first sub-electrode is rectangular, and a length direction (an extension direction) of the rectangle is same as an extension direction of the second electrode 200e. Two second sub-electrodes are provided on two sides of each second electrode block, and a second sub-electrode located between the two second main electrodes is shared by the two second main electrodes. Each second electrode block and two second sub-electrodes disposed thereon are sandwiched between two first sub-electrodes connected to different first electrode blocks. The second main electrode is provided to be composed by second extension parts, and opposite edges of the first sub-electrode and the second sub-electrode are conformal. In the touch unit, portions of the first electrode 100e and the second electrode 200e in each of the touch units are axisymmetric in a transverse direction (a direction of the X axis) and a longitudinal direction (a direction of the Y axis).

For example, in a touch unit shown in FIGS. 20A to 20C, the first electrode 100f includes one first main electrode, and the second electrode 200f includes one second main electrode. In this way, one intersection is formed, the first main electrode includes two first electrode blocks and one first connection part (a conductive bridge as shown in the drawings), and the second main electrode includes two second electrode blocks and one second connection part. Two first sub-electrodes are respectively provided on two sides of each first electrode block, a shape of the first sub-electrode is rectangular, and a length direction (an extension direction) of the rectangle is same as an extension direction of the first electrode 100f. Each second electrode block is provided with six second sub-electrodes, two sides of each second electrode block are respectively provided with three second sub-electrodes, and the six second sub-electrodes are symmetrically arranged in pairs with the second electrode block as a symmetry axis. In this way, each second electrode block and the six second sub-electrodes disposed thereon are sandwiched between two first sub-electrodes connected to different first electrode blocks, a shape of the second sub-electrode is rectangular, and a length direction (an extension direction) of the rectangle is same as an extension direction of the second electrode 200f. The first sub-electrodes and the second sub-electrodes are arranged in a staggered manner, that is, each first sub-electrode is sandwiched between the two second sub-electrodes. Portions of the first electrode 100f and the second electrode 200f in each of the touch units are axisymmetric in a transverse direction (a direction of the X axis) and a longitudinal direction (a direction of the Y axis).

For example, in a touch unit shown in FIGS. 21A-21C, a first electrode 100g includes one first main electrode, and a second electrode 200g includes two second main electrodes. In this way, two intersections are formed, the first main electrode includes three first electrode blocks and two first connection parts (conductive bridges as shown in the drawings), and each second main electrode includes two second electrode blocks and one second connection part. Two first sub-electrodes are disposed on two sides of each first electrode block, a shape of the first sub-electrode is rectangular, a length direction (an extension direction) of the rectangle is same as an extension direction of the second electrode 200g, and two ends of the two second main electrodes are respectively connected to each other. Four second sub-electrodes are arranged on each second electrode block, two second sub-electrodes are arranged on each of two sides of each second electrode block, and the four second sub-electrodes are symmetrically arranged with the second electrode block as a symmetry axis. An extension direction of the second sub-electrode intersects with an extension direction of the first electrode 100g and an extension direction of the second electrode 200g, and the four second sub-electrodes on each second electrode block form an “X” shape. In this way, each second electrode block and the four second sub-electrodes disposed thereon are sandwiched between two first sub-electrodes connected to different first electrode blocks. Portions of the first electrode 100g and the second electrode 200g in each of the touch units are axisymmetric in a transverse direction (a direction of the X axis) and a longitudinal direction (a direction of the Y axis).

The first electrode and the second electrode are required to be spaced apart from each other to form a capacitor, and the first electrode and the second electrode intersect with each other, and two different layers of conductive layers are required to prepare the first electrode and the second electrode to ensure that the first electrode and the second electrode are spaced at an intersection. In addition, a body part of the first electrode and the second electrode may be selected to be disposed on a same layer or different layers, correspondingly, the first connection part and the second connection part may also be faced with a choice of whether or not a bridge structure needs to be set. In the following, structures of the touch unit under different choices described above are illustrated through several specific embodiments.

For example, in the touch panel provided by some embodiments of the present disclosure, a first electrode block and a second electrode block are in a same layer, one of the first connection part and the second connection part is in a same layer as the first electrode block, and another one of the first connection part and the second connection part is a conductive bridge. Exemplarily, as shown in FIG. 8 to FIG. 12, a first connection part 112 is provided as a conductive bridge, and other portions (a first electrode block 111 is included), other than the first connection part 112, of the first electrode 100 are located in same layer as the second electrode 200 (a second electrode block 211 and a second connection part 212 are included). The touch panel may include a substrate 400 and an insulation layer 300, an electrode layer is located on the substrate 400, and the insulation layer 300 is used for spacing a film layer where the first electrode block 111 is located and a film layer where the first connection part 112 is located. A via hole may be formed in the insulation layer 300, and the first connection part 112 is connected to the first electrode block 111 through the via hole.

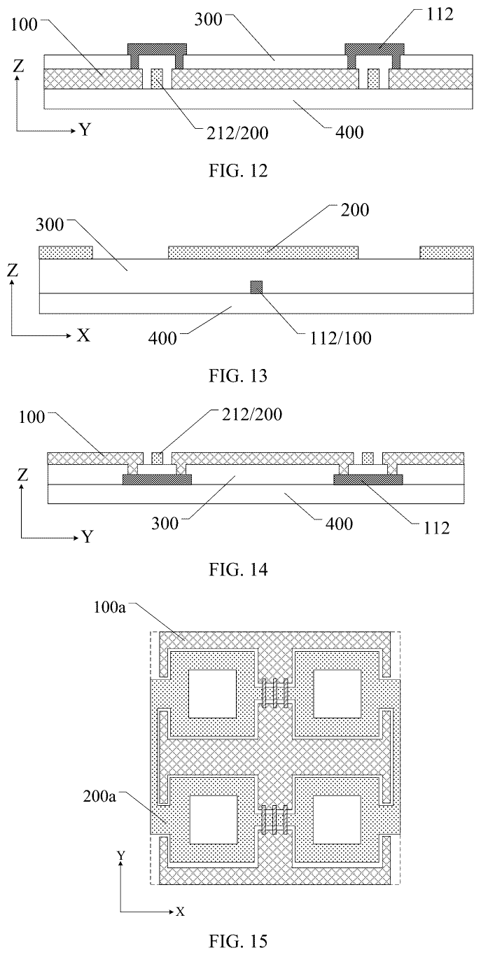

It should be noted that, in some process conditions, the insulation layer 300 is only required to separate the first connection part 112 and the second connection part 212. In this way, the insulation layer 300 may only need to be disposed in an area where the first connection part 112 intersects with the second connection part 212, and the insulation layer 300 does not need to be provided as an entire continuous film layer shown in FIG. 11 and FIG. 12.

In a case that the first electrode block and the second electrode block are in the same layer, an up-down positional relationship between the film layer where the first electrode block is located and the film layer where the first electrode block is located is not limited.

For example, in a specific example, as shown in FIG. 8 to FIG. 12, the film layer where the first electrode block 111 is located, the insulation layer 300 and the film layer where the first connection part 112 is located are sequentially stacked on the substrate 400.

For example, in another specific example, as shown in FIG. 8 to FIG. 10 and FIG. 13 to FIG. 14, the film layer where the first connection part 112 is located, the insulation layer 300, and the film layer where the first electrode block 111 is located are sequentially stacked on the substrate 400.

In a case where body parts of the first electrode block and the second electrode block are in a same layer, it is possible to reduce requirements for an alignment precision of the first electrode and the second electrode in a preparation process, that is, it is possible to ensure that the first electrode and the second electrode may be avoided being connected with each other in a case that a gap between the first electrode and the second electrode is relatively small. In addition, other than an area where the intersection is located, other parts of the first electrode and the second electrode do not overlap, and a light transmittance of an entire electrode layer is relatively uniform in a macroscopic view, and a risk of some areas of the electrode layer being visually visible due to excessive low light transmittance is reduced.

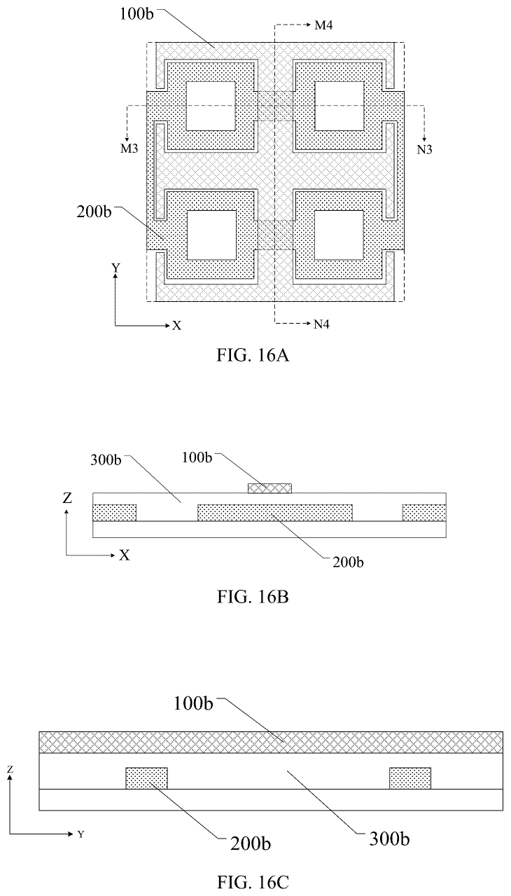

For example, in a touch panel provided by some other embodiments of the present disclosure, a first electrode block and a second electrode block are located in different layers, a first connection part is in a same layer as the first electrode block, and a second connection part is in a same layer as the second electrode block. For example, as shown in FIG. 16A to FIG. 16C, an insulation layer 300b is provided between a first electrode 100b and a second electrode 200b, all parts of the first electrode 100b (including a first extension part, a first electrode block, and a first connection part) are obtained by a patterning process for one conductive film layer, and all parts of the second electrode 200b (including a first extension part, a first electrode block, and a first connection part) are obtained by a patterning process for another conductive film layer.

In a case that the first electrode block and the second electrode block are located in different layers, it is possible to reduce requirements for an alignment precision of the first electrode and the second electrode in a preparation process of the touch panel, that is, it is possible to ensure that the first electrode and the second electrode may be avoided being connected with each other in a case that a gap between the first electrode and the second electrode is relatively small. In addition, other than an area where the intersection is located, other parts of the first electrode and the second electrode do not overlap, and a light transmittance of an entire electrode layer is relatively uniform in a macroscopic view, and a risk of some areas of the electrode layer being visually visible due to excessive low light transmittance is reduced.

In a case that the touch unit is designed to have a smaller capacitance (a constant value, different from a capacitance value), the greater a ratio of a change of the capacitance generated in a touch detection process to the capacitance of the touch unit, that is, the greater a change rate of the capacitance value of the touch unit when the touch unit is touched, and the sensitivity of the touch detection is improved. However, if the capacitance of the touch unit is designed to be too small, it is easy to be affected by other structures (for example, dirt and electrode structures such as a cathode in a display panel), and a difficulty degree of a judgement of a touch recognition is increased. Therefore, it is particularly important that the capacitance of the touch unit is reasonably designed.

For example, in the embodiments of the present disclosure, the first electrode and/or the second electrode is provided with a dummy area, that is, there is no electrode structure in the dummy area, or an electrode structure located in the dummy area does not involved in a composition of the first electrode and/or the second electrode. Exemplarily, as shown in FIG. 8 to FIG. 10, a dummy area 130 is provided in the second electrode block 211 of the second electrode 200. A design area of the second electrode 200 may be adjusted by designing an area of the dummy area 130, to adjust a capacitance of the touch unit formed by the first electrode 100 and the second electrode 200.

For example, in at least one embodiment of the present disclosure, a dummy area may also be provided in a first sub-electrode and/or a second sub-electrode, and details may be referred to the touch unit shown in FIG. 19A to FIG. 19C.

For example, in some embodiments of the present disclosure, a dummy area in a first electrode and/or a second electrode may be a hole digging area, that is, an electrode structure is not designed in the dummy area.

For example, in some other embodiments of the present disclosure, a dummy electrode may be provided in a dummy area in a first electrode and/or a second electrode, and the dummy electrode may be in a same layer and made of a same material as a surrounding first electrode and/or a surrounding second electrode, but both the first electrode and the second electrode are spaced apart from the dummy electrode. In this way, a brightness of a light-emitting surface or a light-reflecting surface (a surface viewed by a user) of a touch electrode layer (the touch panel) may be relatively uniform.

In a touch detection process, a voltage drop is generated on the first electrode and the second electrode, and lengths of signal lines correspondingly connected to each first electrode and each second electrode are inconsistent, and widths of different signal lines are usually designed to adjust a voltage on each first electrode and each second electrode, to maintain touch sensitivity. In the embodiments of the present disclosure, when an electrode pattern in an entire touch unit is substantially fixed, a width of each electrode at an intersection may be designed to regulate a resistance of an entire electrode, to adjust the voltage drop of each electrode.

For example, in each of the touch units of at least one embodiment of the present disclosure, a sum of areas of all of the first electrode blocks is greater than a sum of areas of all of the second electrode blocks, and a design width of the first connection part is less than a design width of the second connection part; or a sum of areas of all of the first electrode blocks is less than a sum of areas of all of the second electrode blocks, and a design width of the first connection part is greater than a design width of the second connection part. A resistance of a current channel of the first electrode and the second electrode is mainly determined by an electrode block and a corresponding connection part, and in this solution, a width of the connection part is designed based on a design area of the electrode block to regulate the resistance of an entire first electrode and an entire second electrode, to adjust the voltage drop of each touch channel.

In some application scenarios, an electrode layer of the touch panel is required to maintain a relatively high light transmittance. For example, when the touch panel is applied to the field of display, the electrode layer is required to be set to be transparent, and light used for displaying an image is emitted. In this case, a transparent conductive material may be selected to prepare the electrode layer, or the electrode layer may be configured as a meshed electrode structure, and the electrode layer is transparent in the visual effect.

For example, in some embodiments of the present disclosure, both the first electrode and the second electrode are continuous electrode structures, and the first electrode and the second electrode are formed of a transparent conductive material. For example, the transparent conductive material may be Indium Tin Oxide (ITO), Indium Gallium Zinc Oxide (IGZO), or the like, or may be a relatively thin (for example, tens of nanometers) metal material.

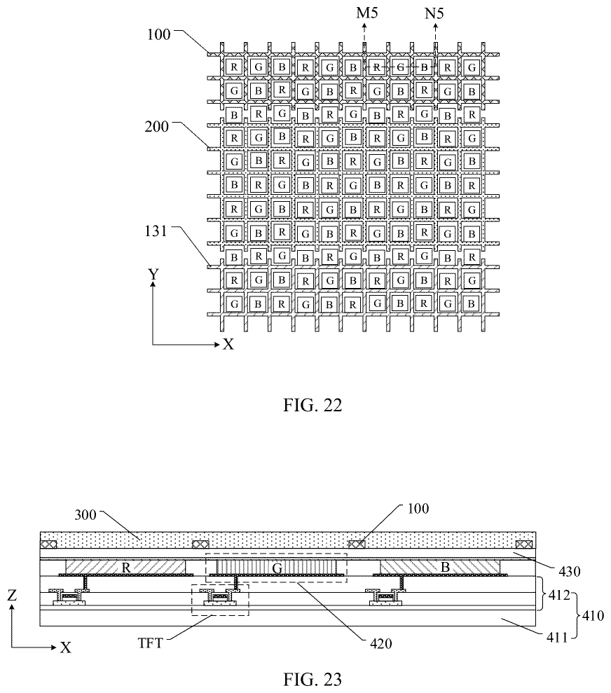

For example, in some other embodiments of the present disclosure, as shown in FIG. 22, a first electrode 100 and a second electrode 200 are mesh electrodes. In this way, a capacitance of a touch capacitor formed by an entire touch unit may be reduced, and a magnitude of a parasitic capacitance generated between the first electrode 100 and the second electrode 200 and other conductive structures (for example, a shielding electrode layer, a cathode layer, or the like) may be reduced, to improve sensitivity of a touch detection. In addition, this design may improve a light transmittance of the touch panel, to further allow materials of the first electrode and the second electrode to be selected from materials (such as a metal or the like) with a high conductivity but poor light transmittance, to reduce a voltage drop of the touch channel and reduce an operating power consumption of the touch panel.

It should be noted that, in a case that a dummy area is provided with an electrode structure, as shown in FIG. 22, an electrode structure 131 in the dummy area may also be set as a mesh electrode. In this way, a transmittance of an entire electrode layer is relatively uniform, to improve a visual effect of the touch panel.

In at least one embodiment of the present disclosure, the touch panel may be further provided with a display function. For example, a substrate of the touch panel may be a display substrate, the display substrate carries the electrode layer and includes a display area, at least a part of the display area is located in the touch function area, and an orthographic projection, on the display substrate, of a mesh line of the mesh electrodes is located between sub-pixels. In one embodiment, as shown in FIG. 22, a blocking degree of the mesh electrodes on light emitted from sub-pixels (for example, R, G, and B three-color sub-pixels) is small, and an entire touch panel (a touch display panel in this case) may have a higher display brightness without increasing a driving power consumption.

For example, as shown in FIG. 22 and FIG. 23, the display substrate may include an array substrate 410 and a display function layer. The display function layer may include light-emitting devices 420 arranged in an array, and the light-emitting devices 420 are physical structures of the sub-pixels, that is, each light-emitting device 420 corresponds to one sub-pixel. The array substrate 410 includes a base substrate 411 and a driving circuit layer 412. The driving circuit layer 412 may include a pixel driving circuit, the pixel driving circuit includes transistors (TFTs in FIG. 23), capacitors, or the like, and the pixel driving circuit is used to drive the light-emitting device 420 to emit light.

For example, in at least one embodiment of the present disclosure, the display substrate may further include an encapsulation layer located on a side, away from the array substrate, of the display function layer. Exemplarily, as shown in FIG. 23, the encapsulation layer 430 covers the display function layer (the light-emitting device 420 is shown therein). The electrode layer used to implement a touch function (which includes the first electrode 100 shown in FIG. 23) is located on the encapsulation layer 430 of the display substrate. In this way, the touch panel may be a touch display panel with a form of Touch On Encapsulation (TOE, which means a tough structure located on the encapsulation layer). For example, a conductive material film layer may be deposited on the encapsulation layer 430, and the conductive material film layer may be patterned to form body structures (for example, an electrode block, a sub-electrode, or the like) of the first electrode 100 and the second electrode 200.

For example, in at least one embodiment of the present disclosure, as shown in FIG. 22 and FIG. 23, mesh openings of the mesh electrodes are set in one-to-one correspondence with sub-pixels (for example, R, G, and B three-color sub-pixels), and each sub-pixel is located within an orthographic projection, on a plane where the display substrate is located, of a mesh opening corresponding to the sub-pixel, that is, the mesh line is located in a gap of the sub-pixels. In this way, the mesh electrodes do not block light emitted from the sub-pixels of the display substrate, to avoid a distortion of a display image of the touch panel (the touch display panel in this case).

It should be noted that an arrangement manner of the sub-pixels may be designed according to actual requirements, and is not limited to a determinant arrangement shown in FIG. 22. Mesh lines of the mesh electrodes may also be designed according to the arrangement manner of the sub-pixels. In addition, in an arrangement of pixels, some sub-pixels with same color of emitted light may be adjacent, and in this case, adjacent sub-pixels with same color of emitted light may be merged to correspond to one mesh opening.

As described above, the embodiments of the present disclosure are beneficial to improve the sensitivity of the touch unit in the touch panel during touch detection. In this regard, the applicant establishes a module design for the touch panel, touch performances of the touch panel before and after using the embodiments of the present disclosure are simulated and compared, which is specifically as follows.

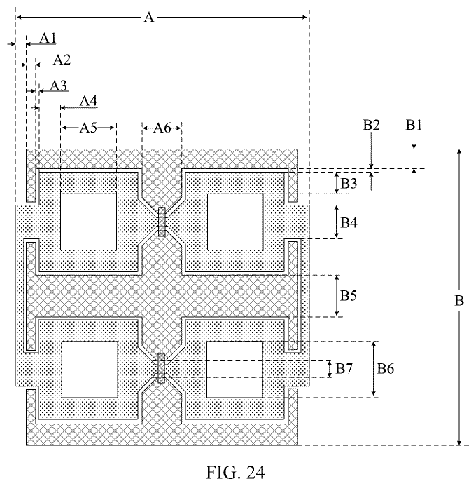

Taking the touch panel as shown in FIG. 4 to FIG. 10 and FIG. 22 to FIG. 24 as an example, the touch panel for simulation provided by the present disclosure is a touch display panel, a lateral length (a size along the X axis) of the touch function area 11 (also equivalent to the display area, which may be referred to as AA area) is 167.87 mm, a longitudinal length (a size along the Y axis) is 267.4 mm, and a size of the touch function area is 12.3 inches, which is also equivalent to 12.3 inches screen. The number of longitudinal channels (channels determined by the first electrodes 100) is 42, and the number of transverse channels (channels determined by the second electrodes 200) is 66. The first electrode 100 and the second electrode 200 are designed as mesh electrodes as shown in FIG. 22, and a mesh opening density is set to 240 PPI. For a size parameter of an electrode pattern of the first electrode 100 and the second electrode 200 in each of the touch units may be referred to FIG. 24 and Table 1 below.

TABLE 1

| Position mark | Parameter | |
|---|---|---|
| A | length of AA/the number of longitudinal | |
| | channels | |
| A1 | 0~¼ | A |
| A2 | 0.1~1 | mm |
| A3 | 0~0.5 | mm |
| A4 | A4 = A2 | |
| A5 | A5 = A − 2*(2*A2) − 2*A1 | |
| A6 | A6 = 2*A2 | |
| B | width of AA/the number of transverse channels | |
| B1 | 0.1~1 | mm |
| B2 | 0~0.5 | mm |
| B3 | B3 = B1 | |
| B4 | 0.2~2 | mm |
| B5 | B5 = 2*B1 | |
| B6 | B6 = B − 2*(4*B1) | |
| B7 | 0.05~0.5 | mm |

In a contrast solution, a shape of the electrode pattern in the touch unit is as shown in FIG. 2, and other parameters such as the size, the number of channels in a transverse direction and longitudinal direction, and the mesh opening density of the touch function area are same as corresponding parameters in the solutions shown in FIG. 4 to FIG. 10 and FIG. 22 to FIG. 24.

In addition, it is assumed that the touch panels used for simulation according to the present disclosure and the contrast solution include a cover plate with a thickness of 0.5 mm, the cover plate is located on a side, away from the display substrate, of the electrode layer used for touch control, and a thickness of the encapsulation layer is designed to be 24 μm. In addition, it is assumed that the first electrode (located in the longitudinal channel) is the sensing electrode, and the second electrode (located in the transverse channel) is the driving electrode.

Based on the parameters above designed, a simulation result of touch performances of the touch panels according to the present disclosure and the contrast solution are shown in Table 2 below. In the table, the Ctx unit represents a capacitance of the driving electrode in each of the touch units, the Crx unit represents a capacitance of the sensing electrode in each of the touch units, the Rtx unit represents a resistance of the driving electrode in each of the touch units, the Crx unit represents a resistance of the sensing electrode in each of the touch units, Rtx represents a resistance of an entire driving electrode, Rrx represents a resistance of an entire sensing electrode, TX-RC Delay represents a delay generated on the driving electrode, and RX-RC Delay represents a delay generated on the sensing electrode.

TABLE 2

| Name | Contrast solution | Present disclosure |
|---|---|---|
| Ctx unit (pf) | 5.3 | 5.59 |
| Crx unit (pf) | 4.8 | 5.25 |
| Rtx unit (Ω) | 28.8 | 26.2 |
| Rrx unit (Ω) | 50.74 | 22 |
| Rtx (Ω) | 1900.8 | 1729.2 |
| Rrx (Ω) | 2131.08 | 924 |
| TX-RC Delay (μs) | 0.3627 | 0.367 |
| RX-RC Delay (μs) | 0.624 | 0.548 |

Based on the data in Table 2, it can be known that, after the electrode pattern involved in FIG. 8 is used in the present disclosure, the resistance of the sensing electrode is greatly reduced, and the delay during touch detection is also significantly reduced, to improve the sensitivity during touch detection.

At least one embodiment of the present disclosure further provides a touch apparatus, which includes the touch panel mentioned in the above embodiments. The touch apparatus may be any product or component having a display function, such as a television, a digital camera, a mobile phone, a watch, a tablet computer, a notebook computer, a navigator, or the like.

The above are only some embodiments of the present disclosure and are not intended to limit the present disclosure, and any modification, equivalent replacement and the like made within the spirit and principle of the present disclosure shall fall within the protection scope of the present disclosure.

What is claimed is:

1. A touch panel, comprising a touch function area and an electrode layer located in the touch function area, wherein the electrode layer comprises:
a plurality of first electrodes arranged in parallel; and
a plurality of second electrodes arranged in parallel, wherein the plurality of second electrodes are arranged to be spaced apart from the plurality of first electrodes and intersect with the plurality of first electrodes to form a plurality of touch units at intersections;
wherein in at least one touch unit of the plurality of touch units, a first electrode of the plurality of first electrodes comprises at least one first main electrode and at least one first sub-electrode connected to a first main electrode in the at least one first main electrode, and
an extension direction of the at least one first sub-electrode is disposed to be parallel to an extension direction of a touch channel determined by at least one of the first electrode and a second electrode in the plurality of second electrodes.

2. The touch panel according to claim 1, wherein in each of the plurality of touch units,
extension directions of first sub-electrodes are same as an extension direction of a touch channel determined by the first electrode, or the extension directions of the first sub-electrodes are same as an extension direction of a touch channel determined by the second electrode; or
each first sub-electrode in the at least one first sub-electrode comprises at least two first extension parts spliced together, an extension direction of a part of the at least two first extension parts is same as an extension direction of a touch channel determined by the first electrode, and an extension direction of another part of the at least two first extension parts is same as an extension direction of a touch channel determined by the second electrode.

3. The touch panel according to claim 1, wherein in each of the plurality of touch units,
ends, facing away from the first main electrode, of all first sub-electrodes are arranged in a plurality of rows, or columns, or rows and columns, directions of the plurality of rows are same as an extension direction of a touch channel determined by the second electrode, and directions of the plurality of columns are same as an extension direction of a touch channel determined by the first electrode.

4. The touch panel according to claim 1, wherein an edge, facing the at least one first sub-electrode, of the second electrode is conformal with an edge, facing the second electrode, of the at least one first sub-electrode.

5. The touch panel according to claim 1, wherein in each of the plurality of touch units, each of the plurality of second electrodes comprises at least one second main electrode and at least one second sub-electrode connected to a second main electrode of the at least one second main electrode, and the first main electrode intersects with the second main electrode.

6. The touch panel according to claim 5, wherein in each of the plurality of touch units, ends, facing away from the second main electrode, of all second sub-electrodes are arranged in a plurality of rows, or columns, or rows and columns, directions of the plurality of rows are same as an extension direction of a touch channel determined by the second electrode, and directions of the plurality of columns are same as an extension direction of a touch channel determined by the first electrode.

7. The touch panel according to claim 5, wherein an extension direction of a second sub-electrode of the at least one second sub-electrode is same as an extension direction of a touch channel determined by the first electrode; or
an extension direction of a second sub-electrode of the at least one second sub-electrode is same as an extension direction of a touch channel determined by the second electrode; or
an extension direction of a second sub-electrode of the at least one second sub-electrode is same as an extension direction of a touch channel determined by the first electrode, and the extension direction of the second sub-electrode is same as an extension direction of a touch channel determined by the second electrode.

8. The touch panel according to claim 7, wherein extension directions of second sub-electrodes are same as the extension direction of the touch channel determined by the first electrode; or
extension directions of second sub-electrodes are same as the extension direction of the touch channel determined by the second electrode; or
the second sub-electrode comprises at least two second extension parts spliced together, an extension direction of a part of the at least two second extension parts is same as the extension direction of the touch channel determined by the first electrode, and an extension direction of another part of the at least two second extension parts is same as the extension direction of the touch channel determined by the second electrode.

9. The touch panel according to claim 7, wherein opposite edges of a first sub-electrode of the at least one first sub-electrode and the second sub-electrode adjacent to each other are parallel to each other, wherein an extension direction of a gap between the first sub-electrode and the second sub-electrode adjacent to each other is same as the extension direction of the touch channel determined by at least one of the first electrode and the second electrode.

10. The touch panel according to claim 9, wherein the first sub-electrode and the second sub-electrode adjacent to each other are arranged in a staggered manner.

11. The touch panel according to claim 5, wherein an extension direction of the second sub-electrode intersects with but is not perpendicular to extension directions of touch channels determined by the first electrode and the second electrode.

12. The touch panel according to claim 5, wherein in each of the plurality of touch units, the at least one first main electrode comprises at least two first main electrodes and the at least two first main electrodes are connected to each other in parallel, or the at least one second main electrode comprises at least two second main electrodes and the at least two second main electrodes are connected to each other in parallel.

13. The touch panel according to claim 12, wherein the at least one first main electrode comprises at least two first main electrodes and the at least two first main electrodes are connected to each other in parallel, and the at least one second main electrode comprises at least two second main electrodes and the at least two second main electrodes are connected to each other in parallel.

14. The touch panel according to claim 5, wherein the first main electrode comprises at least one first connection part and at least two first electrode blocks, the at least two first electrode blocks are connected through the at least one first connection part, respectively, and
the second main electrode comprises at least one second connection part and at least two second electrode blocks, the at least two second electrode blocks are connected through the at least one second connection part, respectively, and the at least one first connection part and the at least one second connection part are located in different layers, respectively, and intersect with each other.

15. The touch panel according to claim 14, wherein the at least two first electrode blocks and the at least two second electrode blocks are in a same layer, one of the at least one first connection part and the at least one second connection part is in the same layer as the at least two first electrode blocks, and another one of the at least one first connection part and the at least one second connection part is a conductive bridge; or
the at least two first electrode blocks and the at least two second electrode blocks are located in different layers, the at least one first connection part and the at least two first electrode blocks are in a same layer, and the at least one second connection part and the at least two second electrode blocks are in a same layer.

16. The touch panel according to claim 14, wherein in each of the plurality of touch units,
a sum of areas of all of the at least two first electrode blocks is greater than a sum of areas of all of the at least two second electrode blocks, and a design width of one of the at least one first connection part is less than a design width of one of the at least one second connection part; or
a sum of areas of all of the at least two first electrode blocks is less than a sum of areas of all of the at least two second electrode blocks, and a design width of one of the at least one first connection part is greater than a design width of one of the at least one second connection part.

17. The touch panel according to claim 1, wherein the first electrode and the second electrode are mesh electrodes.

18. The touch panel according to claim 17, wherein the touch panel further comprises a display substrate, the display substrate is configured to carry the electrode layer and comprises a display area, at least a part of the display area is located in the touch function area, and an orthographic projection, on the display substrate, of a mesh line of the mesh electrodes is located between sub-pixels.

19. The touch panel according to claim 17, wherein mesh openings of the mesh electrodes are in one-to-one correspondence with sub-pixels, and each of the sub-pixels is located within an orthographic projection, on a plane where the display substrate is located, of a mesh opening corresponding to the sub-pixel.

20. A touch apparatus, comprising a touch panel, wherein the touch panel comprises a touch function area and an electrode layer located in the touch function area, wherein the electrode layer comprises:
a plurality of first electrodes arranged in parallel; and
a plurality of second electrodes arranged in parallel, wherein the plurality of second electrodes are arranged to be spaced apart from the plurality of first electrodes and intersect with the plurality of first electrodes to form a plurality of touch units at intersections;
wherein in at least one touch unit of the plurality of touch units, a first electrode of the plurality of first electrodes comprises at least one first main electrode and at least one first sub-electrode connected to a first main electrode in the at least one first main electrode, and
an extension direction of the at least one first sub-electrode is disposed to be parallel to an extension direction of a touch channel determined by at least one of the first electrode and a second electrode in the plurality of second electrodes.
